(19) United States
(12) Patent Application Publication
(10) Pub. No.: US 2003/0078842 A1
(43) Pub. Date: Apr. 24, 2003

(54) Service data delivery scheme

(75) Inventors: Liesbeth M. Scholten, Eindhoven (NL); Paul J. Rankin, Horley (GB); Timothy J. Everett, Thakeham (GB)

Correspondence Address: Corporate Patent Counsel, U.S. Philips Corporation, 580 White Plains Road, Tarrytown, NY, 10591, US

(73) Assignee: KONINKLIJKE PHILIPS ELECTRONICS N.V.

(21) Appl. No.: 10/270,398

(22) Filed: Oct. 11, 2002

(30) Foreign Application Priority Data
Oct. 18, 2001 (GB) 0125023.2

(51) Int. Cl. G06F 17/60

(52) U.S. Cl. 705/14

(57) ABSTRACT

A method for encouraging user (11) access to data services (20) by a portable communications device (18) configured both for communications and to access such data services. Content for presentation on another user device (14) includes embedded connection data allowing the portable device to access the services. The service provider provides incentives both to the user (11) in return for service, and to the provider of content in return for the embedding of the service connection data in the content.

The present invention relates to methods for delivering to a user of a data processing and/or presentation device presenting received content to a user, ancillary data identifying sources of additional information, facilities or services contextually related to the presented content.

In particular, although not exclusively, the invention relates to incentivised schemes by means of which users of such devices may be persuaded to increase their usage in a manner beneficial to the content providers and/or the providers of such additional information, facilities or services.

The data processing and/or presentation device may comprise, for example, a television, set-top box, radio receiver, video cassette recorder, a CD or DVD player, and the received content may comprise audio, video or other data content in encoded or unencoded form, as dictated by user selection and/or preference, or by constraints of the apparatus involved. Whilst the foregoing are described generically herein as consumer electronics or presentation devices and presented content (or content for presentation, as appropriate), it will be recognised that this list is not limiting, that other device and/or content forms may be utilised, and that the term consumer electronics device does not exclude similar devices of so-called professional quality (e.g. audio, video or data handling devices for studio or scientific applications): further and more detailed examples are described in our commonly-assigned co-pending United Kingdom patent application entitled “Service Data Delivery System”. Similarly, the term “portable communications device” as used herein will be understood to include, without limitation, personal and/or mobile telephone, PDA with appropriate communications facility, personal mobile radio and the like, as well as portable devices configured for data transmission and/or reception, such as remote controls and portable MP3 or video players.

The above-mentioned additional information, facilities or services may comprise, for example, data relating to cast, crew or authors for television programmes or movies, information on other recordings by a musician, information on where/how a user may obtain related works for an audio/video presentation, details of public or private services relating to presented content (such as contact details for a medical charity accompanying a television programme relating to a specific ailment), and other public service or advertising material linked to presented content. As above, whilst the foregoing will be described generically herein as ancillary data, for the purposes of clarity only, the term should not be construed as limited to the examples given above, or to further examples given in the following description of preferred embodiments of the invention.

One example of a system for the delivery of contextually related ancillary data is described in the commonly-assigned International patent application no. WO 01/78484 filed Apr. 9, 2001 with a priority date of Apr. 15, 2000 and unpublished at the priority date of the present application. In the system described, a networked communications apparatus comprises at least one server and a plurality of user terminals, together with a portable communications device co-operating with one or more of the user terminals. The coupling between terminal (which may comprise a cable-access television or internet-capable PC) and communications device (which may be a portable telephone or PDA with appropriate communications facility) is by wireless transmission. The portable communications device means for receiving wireless transmissions from the terminal are further configured to receive additional data transmitted wirelessly from other sources, such as message delivery beacons distributed in the locality.

A problem with such systems for data delivery is the need during establishment (especially) and operation to persuade both users of the system and providers of the ancillary services/data that their investment (whether in terms of time or money) is worthwhile. The greater the volume and quality of ancillary data and services that are available to a user, the greater will be the likelihood that a user will be persuaded to use the system on a regular basis.

It is accordingly an object of the invention to provide an improved method for the provision of ancillary data

In accordance with a first aspect of the present invention, there is provided a method for the incentivising of user access to data services by a portable communications device configured both for communications and to access such data services, wherein a consumer electronics device is arranged to receive content and present the same to a user; and wherein one or more services related to said content received by said consumer electronics device are provided, with connection data for said service or services being delivered to said consumer electronics device in conjunction with said content, said connection data being transmitted therefrom to said portable electronics device, said portable communications device being thereby enabled to establish a connection to said service or services at least partially in dependence on said connection data, and the user of the portable device being provided with an incentive to establish such a connection. With the use of incentives to increase the volume of access to services, it is more important than ever that the act of accessing is made easier for users: here that improved access results from the delivery of connection data in content to the user

Such incentives may be in financial terms (for example cheaper access to goods or services) or may comprise other forms such as privileged access to items unavailable to the general public. The incentives may be time dependent, with associated expiry dates for special offers or limited availability on a first-come, first-served basis.

Incentives may also be provided in the form of financial returns from the service provider to the content provider in return for the inclusion of that service provider's connection data in delivered content. Such financial return may me set on the basis of the number of times the connection data is broadcast, or the number of times it is actually used by users to contact the service provider.

Further features of the present invention are defined in the attached claims, to which the readers attention is now directed, and the disclosure of which is incorporated herein by reference.

Additional features and advantages of the present invention will become apparent from reading of the following description of preferred embodiments, given by way of example only, and with reference to the accompanying drawings, in which:

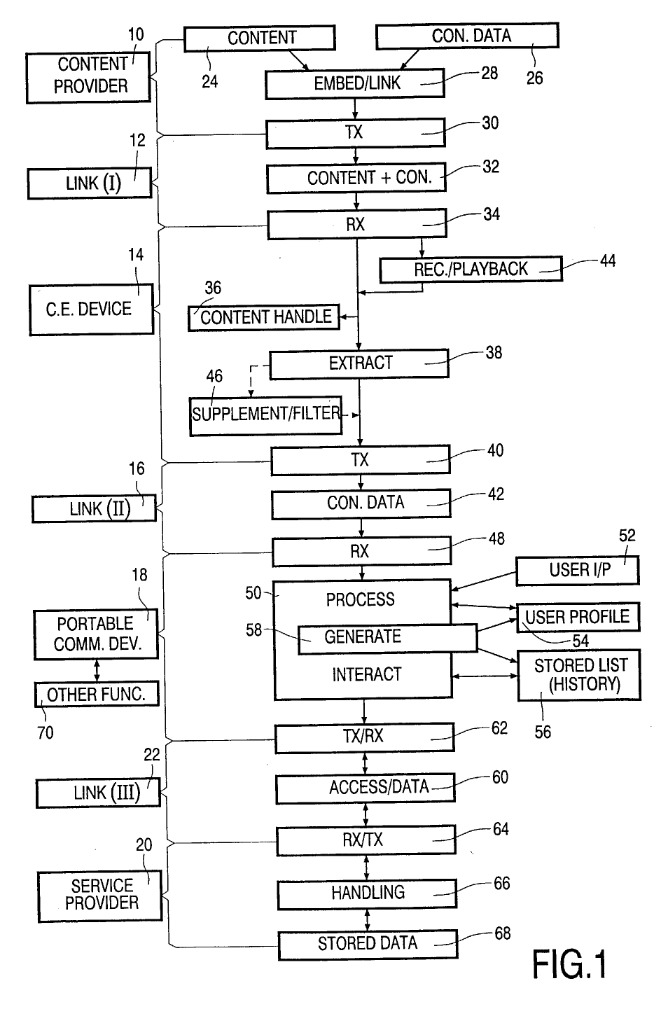

FIG. 1 schematically represents the delivery of content with connection data and the use of such connection data to access ancillary services;

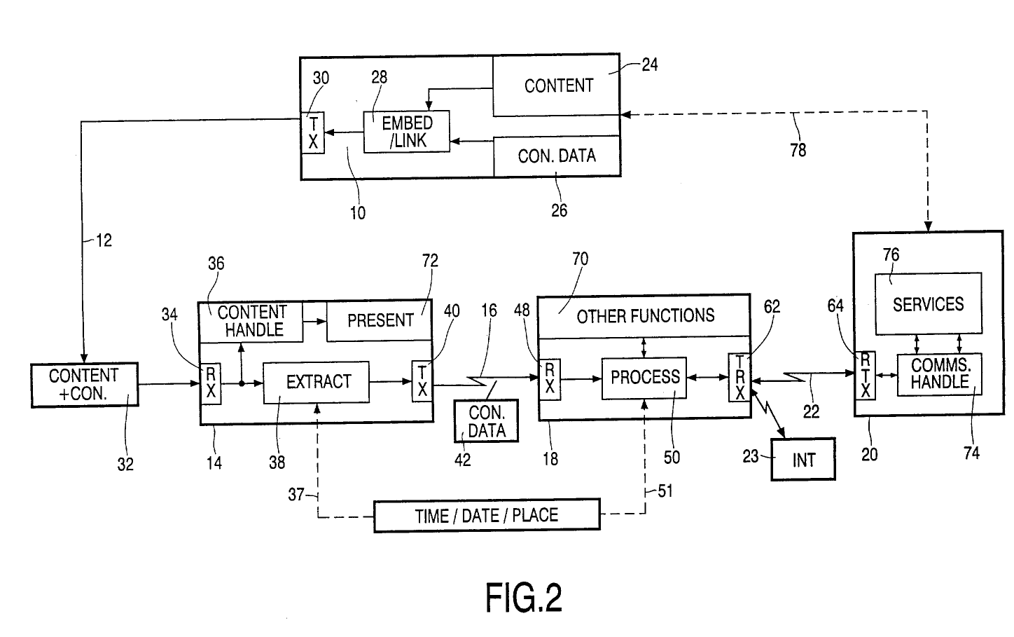

FIG. 2 is a generalised schematic diagram of a consumer electronics device and portable communications device suitable for use in support of the method of the present invention;

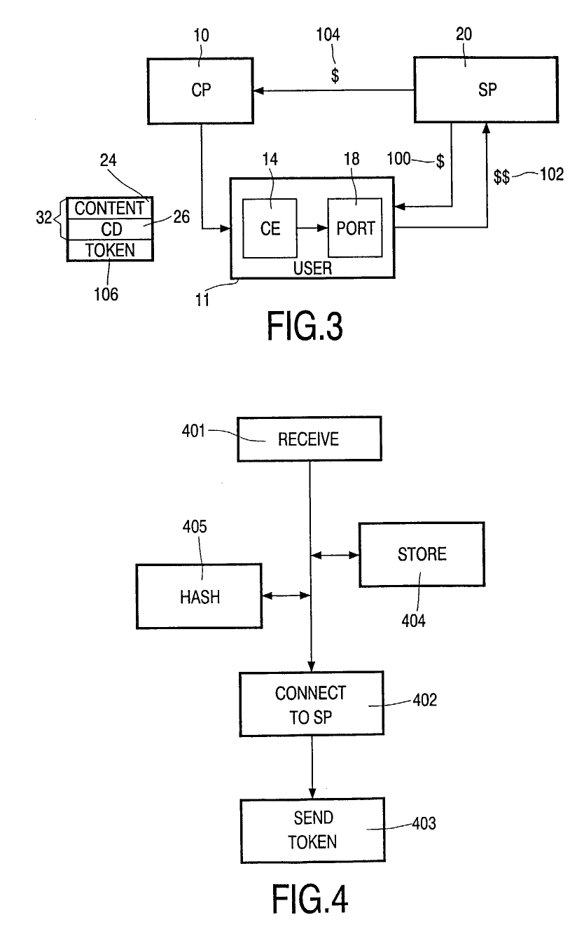

FIG. 3 schematically represents the passage of incentives in accordance with the invention;

FIG. 4 is a flowchart representation of the handling of tokens in equipment of a user; and

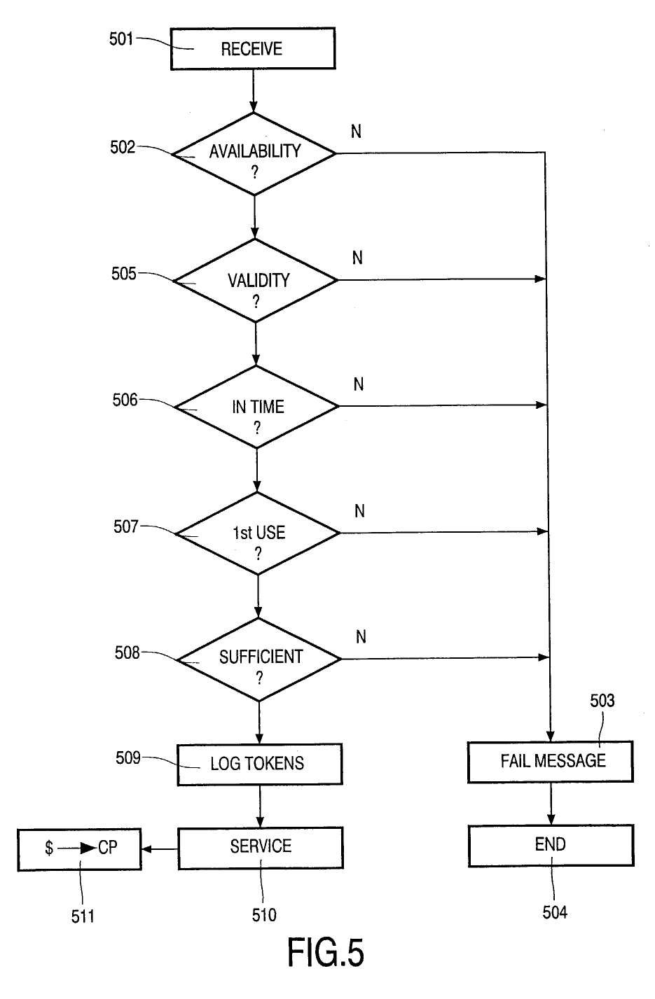

FIG. 5 is a flowchart representation of the handling of the tokens from FIG. 4 by a service provider.

In the following description of preferred embodiments of the present invention, like features are designated by a common reference numeral throughout and are not separately described in detail for each such embodiment save where required for illustrating operational features of that particular embodiment. Features defined in both generic and specific implementations are identified by a reference numeral only in their generic form, and by the same reference numeral with a respective different added alphabetic suffix for each different specific implementation. Unless otherwise indicated by the context, references to items or features in the singular do not preclude the provision or use of those features in plural, and vice versa.

FIG. 1 schematically represents the delivery of content with connection data and the use of such connection data. The chain of delivery through to use commences at content provider 10, via a first link 12 to a consumer electronics device 14, from the consumer electronics device 14 via a second link 16 to a portable communications device 18, and concludes with use in the form of interaction between the portable communications device 18 and a provider of data services 20 over a third link 22. Different forms and constructional features for the providers 10,20, devices 14, 18, and connecting links 12, 16, 22 are described below with reference to FIG. 2 et seq.

At content provider 10, a source of content 24 for the consumer electronics device 14 is provided, together with a source of connection data 26. The connection data 26 comprises such data as will enable the suitably configured portable communications device 18 to access specific data services hosted by data service provider 20, which services are related to the content delivered to the consumer electronics device 14: as an example, where the content 24 comprises a broadcast television programme, the connection data 26 may enable access to a web site carrying additional data related to the programme (such as background to a particular story line, biographies of cast and producers), access to an on-line ordering service (from which merchandise related to the programme may be ordered), or access to a telephone messaging service where the user can hear messages from, or leave messages for, members of the cast.

The content provider 10 conjoins the content 24 and connection data 26 at step 28, suitably by embedding the connection data 26 in the content 24, or by otherwise linking the two for transmission 30 over link 12 to the consumer electronics device 14. One suitable method for embedding the connection data is to include it as periodic or aperiodic data objects in a stream of other data objects carrying the content: meta data tags may then be used to identify the connection data objects and permit their subsequent extraction.

The transmitted conjoined content and connection data 32 is received at 34 by the consumer electronics device 14 and passed to content handling stage 36 which processes the received content appropriately whilst ignoring the connection data. As an example, where the consumer electronics device 14 is a television receiver, the content handling will include the separation and presentation of audio and video content, decoding and making available of teletext data services, and so forth.

In one arrangement, the connection data within the conjoined content and connection data 32 is passed transparently through the consumer electronics device 14, that is to say it is passed directly from receiver 34 to an extraction stage 38 which extracts the connection data from the conjoined stream (suitably by simply ignoring everything but the connection data) and then prepares and transmits 40 the prepared connection data 42 to the portable communications device 18 via link 16. As will be understood, rather than present the content immediately on receipt, the device 14 may be able to record received content for later playback: in such a case the device is suitably arranged to record and playback 44 the received content with embedded or linked connection data. On playback of such stored or recorded data, the connection data is extracted 38 from the played back content and data whilst the content is handled 36 as before.

In an alternative to the transparent passing of the connection data from receiver 34 via the extraction stage 38 to transmission 40, the extracted connection data may be passed to a supplementing stage 46 (the links to and from which are indicated by dashed lines) which adds to, or otherwise modifies, the connection data. The supplementing may involve the adding of data gathered in the consumer electronics device identifying, for example, a television or radio station that the user has currently or recently tuned to, or other data which may be utilised in customising or otherwise scheduling services from the service provider 20. As an alternative or additional process to supplementing, the stage 46 in consumer electronics device 14 may correlate the connection data against a stored record of user preferences and prioritise or filter connection data for preferred service providers or services. This prioritisation may take the form of augmenting the connection data sent to indicate a priority, or it may take the form of the stage 46 selectively filtering non-priority items, such that only priority items are passed. Where the connection data contains some indication of the additional content available from the service provider, the filtering may be set to exclude connection to services of no interest to the user, or the facility may be used for parental control to block connection data identifying services carrying adult material.

Where there is access to a real time clock in the consumer electronics device 14 or portable communications device 18, filtering or access control may be applied on the basis of the current time and/or date, for example to make some additional content only available on special occasions such as Christmas or birthdays. For additional content of an adult nature, a watershed time (such as 9.00 pm) may be set by a parent or guardian to prevent access before this time.

Where there is access to a source of location data, filtering or access control may be applied on the basis of user location. This may take the form of selecting appropriate language for presentation of the additional content, or the making available of relevant additional content specific to the users local area (for example, the user watches a television program about history, and the additional content identified by the connection data comprises URL's for websites hosted by one or more local museums).

With filtering on the basis of time/date and/or location, it is not necessary to broadcast plural streams, each carrying different sets of connection data.

Having traversed the second link 16, the connection data 42 is received 48 by the portable communications device 18, and passed to a data processing and interaction stage 50 which is thereby enabled to establish a connection to the service or services from service provider 20 at least partially in dependence on said connection data. The accessing of data services may be automatic on receipt of the connection data or may be in response to a predetermined user input 52 to the device: the input may be a simple response to an indication that connection data has been received (e.g. a LED lights up on the portable communications device or, where it has the facility to display messages, may be a simple confirmatory response to a message such as “SERVICE CONNECT: YES/NO?”) or it may be more complex (such as requiring user selection from a menu of selected available service options, as described in greater detail hereinafter). As above, prioritisation and/or filtering may be applied within the portable device to simply delete connection data for service provider sites known to be of no interest or to block access to inappropriate sites.

The portable communications device processing and interaction stage 50 may be arranged to automatically access said data services in response to receipt of the connection data 42 from the consumer electronics device if one or more predetermined conditions are met. Such a condition may be the matching of at least a part of the connection data 42 with one or more aspects of a profile of the user 54 stored in the portable communications device. For example, where the user profile indicates an interest in sports, and the connection data includes classification of a particular data service as relating to sport, the processing stage 50 could directly establish a connection to that service (with or without first seeking user input 52), in preference to a data service for which connection data has been received, but for which no match occurs in the stored profile. Where connection data is received whilst there is no profile-matching data service currently identified, such other services may suitably be offered to the user.

In an alternative (or addition) to the use of a stored user profile 54, the portable communications device may maintain a list 56 of past user interactions with data services, so that those services known to be of interest to a user may be connected to directly when the connection data for them is next received. Whilst the profile 54 and/or list of favourite services 56 may be downloaded or otherwise input to the portable communications device, they may instead be generated 58 within the device based on a history of past interactions by the user with one or more data services.

Interaction with data services over link 22 is a two-way process with accessing commands (based on the connection data) and data 60 from the service provider 20 passing between respective transmission and receiver stages 62, 64 of the portable device 18 and service provider 20. At the service provider, from the reception/transmission stage 62, the received accessing commands are processed in a handling stage 66 with reference to stored data 68, with service data being extracted and delivered to the portable device.

As indicated generally at 70, the portable communications device 18 is additionally able to perform other functions, typically those communications or data passing functions dictated by the form of device itself (e.g. connection to telecommunications networks or remote controlling of the consumer electronics device).

FIG. 2 is a generalised schematic diagram of a system for the enabling of access to data services, comprising a content provider 10 coupled by a link 12 to a consumer electronics device 14 arranged to receive the embedded or linked content and connection data 32. The link 12 may be provided over a number of networks, such as GSM, GPRS, 3G, or cellular, and in a number of media forms, including voice data, text, video, SMS, and WML cards: other forms will be apparent to the skilled reader.

A portable communications device 18 is provided to receive the connection data 42 from the consumer electronics device 14 via link 16 and, via link 22, to support the user interaction with the service provider 20.

The content provider 10 includes a source of content 24 for delivery to the consumer electronics apparatus 14. Where the content provider is a television or radio broadcaster, for example, the content from source 24 may suitably comprise television or radio programmes (composed live or prerecorded) for delivery via the link 12 to a consumer electronics device 14 in the form of a television, set top box, radio receiver etc. The content provider also includes a source of connection data 26 which connection data identifies a source of further information ancillary to the subject matter of respective items or sources of the content from source 24. The content provider 10 further comprises an embedding or linking stage 28 which stage is operable to put together items of content from source 24 with the appropriate connection data from source 26. This conjoined content and connection data 32 is delivered via the link 12 the form of which may include a number of variations, such as wireless, cable or satellite broadcast channels or it may be via mechanical means including the recording of the content and connection data 32 onto a storage medium (for example optical disc, video cassette tape and so forth) with the “transmission” of the content and connection data comprising the physical transfer of a removable record carrier from the content provider 10 to the—suitably configured—consumer electronics device 14.

The consumer electronics device 14 includes means 34 for receiving the transmitted content and connection data 32. The form and configuration of the receiver 34 will depend on the means by which the data is transmitted from the content provider 10. Where the data is broadcast (wirelessly or otherwise), the receiver 34 will be a suitable broadcast receiver; where the means for delivering the content and connection data is a removable record carrier, the receiver 34 will instead comprise an appropriately configured means for extracting the content and connection data from such a record carrier when received. An example of this latter arrangement would be an optical disc reader where the content and connection data are delivered on disc.

From the receiver 34, the content is passed to content handling stage 36 and from there to a presentation stage or device 72. The nature of content handling will depend to a certain extent on the nature of the content and the requirements for processing or otherwise treating the content prior to presenting it to the user of the CE device 14. Likewise, the presentation means 72 may take a number of forms as dictated by the configuration of the CE device: for example, where the consumer electronics device 14 is an audio broadcast receiver, the content handling stage 36 may include means for digital or analogue processing of the received audio signal, and the presentation means 72 may comprise an amplifier coupled to provide an output to one or more speakers or headphones. Although CE device 14 is shown as a single device in FIG. 2, it will be readily appreciated that it could equally comprise a distributed system of interconnected devices.

Also connected to the receiver 34 within the CE device is an extraction stage 38 which receives the incoming content and connection data 32 and separates the connection data, which connection data relates to the content currently handled by stage 36. As illustrated by dashed line 37, the extraction stage 38 may be provided with a source of time/date and/or geographical location data, to enable filtering of the received connection data as described previously. The source of time/date data may be an internal clock within the device 14, or such data may be carried by (and extracted from) the received content. The source of location data may also be an internal device such as a GPS receiver or location beacon, or it may be supplied from nearby by a linked device with location determining capability. From the extraction stage 38, the connection data 42 is output via a data transmitter 40 of the consumer electronics device 14 and from there transmitted via link 16 to a receiver 48 in portable communications device 18. The link 16 may comprise a permanent or temporary wired link between transmitter 40 and receiver 48 but, preferably, it comprises a short range wireless link such as an RF or infra red link, with communications over said link 16 conforming to predetermined data protocols such as, for example, Bluetooth, 802.11, 802.15.4, Zigbee and so forth.

Within the portable communications device 18, the received connection data is passed from receiver 48 to processing stage 50 where the contained network addresses, telephone numbers or other connection data is extracted. In conjunction with transceiver 62, the processor 50 of the portable communication device is then able to establish communications with service provider 20 via further link 22 (between transceiver 62 and a further transceiver 64 of the service provider). As before, the form of link 22 may vary to include wired or wireless connections optionally via telephone or other data networks. Also, as indicated by dashed line 51, the processor may provided with a source of time/date and/or location data to enable filtering of received connection data as described above.

As will be recognised, the portable communications device will have a primary function other than supporting user interaction with the service provider 20 and, in a typical configuration, the device 18 may comprise a portable telephone, a laptop computer, a remote controller (suitably configured to control operation of the CE device 14 via wireless link), or a personal digital assistant (PDA), each equipped with suitable communications facilities to support links 16 and 22. Other device types will suggest themselves to the skilled reader, and the term “portable communications device” should be construed only as requiring that a user may transport the device from place to place and that it support links 16 and 22. In the case of configuration as a portable telephone, it will be recognised that at least link 22 may be handled by the telephone's conventional communications systems if interaction with the service provider 20 takes place via a telephone connection. In FIG. 2, the other general functional features of the portable communications device 18 not contributing to the interaction with service provider 20 are indicated generally at 70.

The service provider 20 receives communications from the portable device 18 at transceiver 64 (and returns service data to the user via the same) with communications received at transceiver 64 being processed in communications handling stage 74 which in turn is coupled with a source of service data 76 forming the basis for the interaction between the user of the portable device 18 and the service provider 20. As will be recognised (and as illustrated by dashed line 78) due to the relationship of the provided services to the content being delivered to the user's consumer electronic device 14, a link is likely between the content and service providers 10, 20. Where the content provider 10 is a broadcaster, they may also create the service data 76 and either supply it to a third party service provider 20 for onward transmission to a portable device user or they may themselves act as service provider 20. It will be further recognised that, rather than the communications device 18 being directed to establish communication with service provider 20 directly, the connection data 42 forwarded from CE device 14 may instead specify an intermediary location or service (INT) 23 from which the portable communications device 18 may obtain an appropriate source address from which to obtain service data, the data from the intermediary location 23 being passed back via transceiver 62 to processor 50 and thereafter handled as connection data 42 in the manner described above. The introduction of such an intermediary step may be favoured in that it can allow upgrading of the service data and changes to the storage location thereof without requiring the connection details embedded in content 32 to be changed which can be a major advantage where the connection data is embedded in content on a pre-recorded disc or other storage medium which the user may wish to replay many months (or years) after the initial creation and delivery of the content.

The general path for the passing of incentives is illustrated in FIG. 3, with the content provider 10 and service provider 20 shown as before, and the user (consumer electronics device 14 and portable device 18) shown generally at 11. The first incentive may be considered to be the connection data 26 made available to the user 11 with content from the content provider 10. In interaction between the user 11 and service provider 20, various actual or perceived financial incentives 100 may be provided to the user (for example in terms of discounts for services or goods) although the net flow 102 will be towards the service provider.

A further financial inducement or payment 104 is from the service provider 20 to the content provider 10, representing a payment for including the service providers connection data in the content delivered. The level of this return may be determined in a number of ways: for example, it may be a one-off payment, or it may be variable depending on the number of times the content provider sends out the connection data or the number of user contacts the service provider receives from sent connection data.

As represented at 106, the content and connection data sent to a user may include one or more service tokens or credits which may be exchanged with the service provider in full or part payment for goods or services, or may permit access to services not generally available to the public. Various aspects and options for such token use are described below with reference to the flowcharts of FIGS. 4 and 5 respectively a number of optional procedures that may be implemented within the user 11 equipment and at the service provider 20.

In the user's equipment, the content, connection data and token or tokens are received at 401. Based on the connection data, a connection to the service provider is established at 402, with interaction (including the sending of the token or tokens) occurring subsequently at 403. A first optional process at 404 is the storing of a received token or tokens: this may be used where the service provider makes available special offers in return for user loyalty, which loyalty is indicated by requiring them to accumulate tokens over several interactions. A second optional process at 405 is to personalise the tokens to give them a unique identity detectable by the service provider (optionally as a security control to prevent fraudulent reuse of tokens). A suitable method for creating the unique identity is to give each token a unique code when it is package for delivery by the content provider 10, and then for each user receiving a copy of that token to hash (or otherwise modify) the code with an individual code for the user apparatus.

Turning now to FIG. 5, the handling of tokens by the service provider commences with receipt of one or more tokens from a user at 501. Accompanying that token or tokens will be an indicator of the service that the user seeks to access (if the service provider hosts more than one, without separate access mechanisms for each), or the received message will simply indicate the receipt of a request for the one service available. At 502, a first check is made as to whether the service is available (some may be seasonal or otherwise time limited) and, if not, a suitable error message is returned to the user at 503, and process terminates at 504.

If the service is available, the first of a number of optional token checks is carried out at 505 checking whether the token is valid for full or part payment for access to the services, or is otherwise acceptable to the service provider for accessing special or particular services. That part of the unique code added to the token by the content provider may be agreed with the service provider (or specified thereby) such that the code section provides a validity check for the service provider.

In addition to services being only available seasonally as mentioned above, access to those services may be restricted for individual users according to the availability or otherwise of special tokens that would permit access to those services. In one example, certain services may only be available to users who have just viewed a broadcast of a particular television programme (in which content the connection data and token was provided) with the tokens enabling access including an expiry date and/or time beyond which they will not be accepted by the service provider. Such time limiting of tokens (a test for which is included at 506) not only controls the volume of user accesses to a particular service, but also encourages the user to access the service before the token expires. In a variant on this, the service may comprise a prize selection in conjunction with a particular presented television programme or other item of content: at a certain point in the broadcast, the connection data and token will be delivered, and at a subsequent point (alerted to the users) the prize service goes live, with the first connecting user receiving the largest prize, with a series of diminishing size prizes for a predetermined number of subsequent user connections.

To prevent copying and re-use of the tokens, the unique token plus user device code for each received and redeemed token is suitably logged to allow a check (at 507) as to whether a token has already been used, and is hence no longer valid. Where the store of received token identifier codes includes facility for logging numbers of receipts against each (or at least a subset of tokens), multiple use tokens may be provided to encourage re-visiting of services without awaiting supply of a new token.

As mentioned, in some arrangements the user devices 11 may have facility to capture and store received tokens to facilitate access to those services for which a single token is insufficient. This arrangement may stimulate loyalty in users to a particular deliverer of content, or a particular stream of content delivered, with sufficient appropriate tokens for access only being available through capturing the content and tokens on more than one previous occasion. A further optional test is therefore provided at 508 to ensure that sufficient tokens are submitted for access to the service sought.

If any of the tests 505 to 508 is failed, an error message 503 is sent preceding termination 504, as for the availability test 502. If all tests are passed however, then following logging of the identities for the received tokens at 509, the service interaction 510 occurs. As indicated at 511, contingent upon the service interaction, a reward or payment may be authorised or sent for the content provider in recognition of the access of the user using the transmitted connection data.

Although defined principally in terms of a software-based or controlled implementation, the skilled reader will be well aware than many of the above-described functional features could equally well be implemented in hardware or a combination of software and hardware.

From reading the present disclosure, other modifications will be apparent to persons skilled in the art. Such modifications may involve other features which are already known in the design, manufacture and use of consumer electronics devices, portable telecommunications devices and/or data network access apparatus and devices and component parts thereof and which may be used instead of or in addition to features already described herein.

1. A method for the incentivising of user access to data services by a portable communications device configured both for communications and to access such data services, wherein a consumer electronics device is arranged to receive content and present the same to a user; and
wherein one or more services related to said content received by said consumer electronics device are provided, with connection data for said service or services being delivered to said consumer electronics device in conjunction with said content, said connection data being transmitted therefrom to said portable electronics device, said portable communications device being thereby enabled to establish a connection to said service or services at least partially in dependence on said connection data, and the user of the portable device being provided with an incentive to establish such a connection.

2. A method as claimed in claim 1, wherein said service or services are provided to the user with a financial reward for establishing the connection thereto.

3. A method as claimed in claim 2, wherein the level of said financial reward diminishes with time from when it was first made available.

4. A method as claimed in claim 1, wherein said connection data includes at least one data token, exchangeable for goods or services from a provider of said service or services.

5. A method as claimed in claim 4, where the user is required to pay a predetermined price for said goods or services and the exchange of said data token provides a discount to said price.

6. A method as claimed in claim 4, wherein the user is provided with means to store said tokens, and the exchange for goods or services requires exchange of a user-accumulated plurality of said tokens.

7. A method as claimed in claim 4, wherein the user is provided with means to store said tokens, and wherein each token has an associated lifetime beyond which it ceases to be acceptable for exchange by the provider of said service or services.

8. A method as claimed in claim 4, wherein each of said tokens is usable for exchange on a single occasion, with the provider of said service or services checking for re-use of tokens and rejecting any used tokens.

9. A method as claimed in claim 8, wherein each token included in connection data is given a new identity code each time it is sent by the content provider, which code is combined in the consumer electronics device or portable communications device with a unique identifier for that device to provide a unique identifier code for each exchangeable token, with the provider of said service or services maintaining a record of the unique identifier codes of all received tokens.

10. A method as claimed in claim 1, wherein a finite number of user incentives are made available on a first come, first served basis.

11. A method as claimed in claim 1, wherein the provider of said service or services provides a financial return to the provider of said content to the user in return for the inclusion of connection data to said service or services in said content.

12. A method as claimed in claim 11, wherein the level of said financial return is determined by the number of times the provider of said content includes said connection data.

13. A method as claimed in claim 11, wherein the level of said financial return is determined by the volume of user accesses to said service or services using said connection data.
